(19) United States
(12) Patent Application Publication
(10) Pub. No.: US 2023/0370965 A1
(43) Pub. Date: Nov. 16, 2023

(54) SHIP COMMUNICATION SYSTEM, METHOD, TRANSMISSION DEVICE AND COASTAL CALCULATION CENTER

(71) Applicant: MARS SEMICONDUCTOR CORP., HSINCHU CITY (TW)

(72) Inventor: CHUN-CHUAN CHEN, HSINCHU CITY (TW)

(21) Appl. No.: 17/951,634

(22) Filed: Sep. 23, 2022

Related U.S. Application Data
(60) Provisional application No. 63/364,529, filed on May 11, 2022.

(51) Int. Cl. H04W 48/20; H04B 7/185

(52) U.S. Cl. CPC H04W 48/20; H04B 7/1851

(57) ABSTRACT

A ship communication system has a coastal calculation center and at least one of ships. The ship has a transmission device having a first communication module, a second communication module and a controlling and processing core. The first communication module is configured to communicate with a satellite communication device. The second communication module is configured to communicate with a base station. The controlling and processing core is configured to determine whether the second communication module is able to communicate with the base station. When the second communication module is able to communicate with the base station, the ship utilizes the second communication module perform data transmission with the coastal calculation center via the base station; when the second communication module is unable to communicate with the base station, the ship utilizes the first communication module perform data transmission with the coastal calculation center via the satellite communication device.

### TECHNICAL FIELD

The present disclosure relates to a ship communication system, a ship communication method, a transmission device and a coastal calculation center, and particularly to, a ship communication system and method which make a coastal calculation center communicate with ships depart away from and come to the coast, and to a transmission device used in the ship and a coastal calculation center which provides services.

### RELATED ART

At present, when a ship departs away from a port on duty, it can only perform positioning through satellite communication, and can perform voice communication or text information exchange with low transmission volume with a coastal calculation center through the satellite communication. Due to limitations of a transmission speed and a transmission bandwidth of the satellite communication, an entire ship data including healthiness scores of devices, facilities and the ship as a whole and various parameters are only displayed on the screen of the control room of the ship, but not transmitted to the coastal calculation center. Simply put, the satellite communication cannot provide large data transmission for the coastal calculation center located at a coast and the ship on duty leaving the port.

Although it is possible to design a dedicated satellite regardless of the cost to provide the exclusive communication bandwidth for the ship and the coastal calculation center, this approach is not economical. In view of this, it is still necessary to provide a ship communication system, a method, a transmission device and a coastal calculation center to solve the above technical problems.

### SUMMARY

An exemplary embodiment of the present disclosure provides a ship communication system, and the ship communication system comprises a coastal calculation center located on a coast and at least one of ship, wherein the ship is configured to have a transmission device comprising a first communication module, a second communication module and a controlling and processing core. The first communication module is configured to communicate with a satellite communication device. The second communication module is configured to communicate with a base station. The controlling and processing core is electrically connected to the first communication module and the second communication module, and configured to determine whether the second communication module is able to communicate with the base station. When the second communication module is able to communicate with the base station, the ship utilizes the second communication module perform data transmission with the coastal calculation center via the base station; When the second communication module is unable to communicate with the base station, the ship utilizes the first communication module perform data transmission with the coastal calculation center via the satellite communication device.

According to the above ship communication system, wherein when the ship departs away the coast, the second communication module is unable to communicate with the base station, and the first communication module is utilized to transmit real-time health information of the ship to the coastal calculation center via the satellite communication device.

According to the above ship communication system, wherein when the ship comes to the coast, the second communication module is able to communicate with the base station, the second communication module is utilized to transmit an entire ship data of the ship to the coastal calculation center via the base station, and the coastal calculation center updates a system of the ship and at least a health prediction model of the ship are updated via the base station.

According to the above ship communication system, wherein the coastal calculation center performs trend analysis and data correlation analysis based on the entire ship data.

According to the above ship communication system, wherein the controlling and processing core is configured to predicate a healthiness score of a device in the ship, a healthiness score of a facility in the ship or a healthiness score of the entire ship by using the health prediction model.

According to the above ship communication system, wherein the transmission device further comprises a storage module. The storage module is electrically connected to the first communication module, the second communication module and the controlling and processing core, and configured to store an entire ship data of the ship, real-time health information of the ship, a health prediction model and system information.

According to the above ship communication system, wherein the second communication module communicates with the base station by using a fourth-generation mobile communication standard, a fifth-generation mobile communication standard, a wireless wide area network standard, a wireless local area network standard, a microwave communication standard or a privacy WiFi (PWiFi®) standard.

According to the above ship communication system, wherein the controlling and processing core determines whether the second communication module is able to communicate with the base station according to at least one of a locating signal of the ship, a wireless signal power or a manual switching signal, wherein the wireless signal power is a power of a wireless signal which is transmitted to second communication module from the base station.

An exemplary embodiment of the present disclosure provides a ship communication method, comprising steps as follows: determining whether a ship is able to communicate with a base station; when the ship is unable to communicate with the base station, the ship performs data transmission with a coastal calculation center located on a coast via a satellite communication device; and when the ship is able to communicate with the base station, the ship performs the data transmission with the coastal calculation center via the base station.

An exemplary embodiment of the present disclosure provides a transmission device used in a ship. The transmission device is configured to perform data transmission with a coastal calculation center located on a coast, and comprises a first communication module, a second communication module and a controlling and processing core. The first communication module is configured to communicate with a satellite communication device. The second communication module is configured to communicate with a base station. The controlling and processing core is electrically connected to the first communication module and the second communication module, configured to determine whether the second communication module is able to communicate with the base station. When the second communication module is able to communicate with the base station, the ship utilizes the second communication module to perform the data transmission with the coastal calculation center via the base station; when the ship is unable to communicate with the base station, the ship utilizes the first communication module to perform data transmission with the coastal calculation center via the satellite communication device.

According to the above transmission device, wherein when the ship departs away the coast, the second communication module is unable to communicate with the base station, and the first communication module is utilized to transmit real-time health information of the ship to the coastal calculation center via the satellite communication device.

According to the above transmission device, wherein when the ship comes to the coast, the second communication module is able to communicate with the base station, the second communication module is utilized to transmit an entire ship data of the ship to the coastal calculation center via the base station, and the coastal calculation center updates a system of the ship and at least a health prediction model of the ship are updated via the base station.

According to the above transmission device, wherein the controlling and processing core is configured to predicate a healthiness score of a device in the ship, a healthiness score of a facility in the ship or a healthiness score of the entire ship by using the health prediction model.

According to the above transmission device, wherein the transmission device further comprises a storage module. The storage module is electrically connected to the first communication module, the second communication module and the controlling and processing core, and configured to store an entire ship data of the ship, real-time health information of the ship, a health prediction model and system information.

According to the above transmission device, wherein the second communication module communicates with the base station by using a fourth-generation mobile communication standard, a fifth-generation mobile communication standard, a wireless wide area network standard, a wireless local area network standard, a microwave communication standard or a privacy WiFi (PWiFi®) standard.

According to the above transmission device, wherein the controlling and processing core determines whether the second communication module is able to communicate with the base station according to at least one of a locating signal of the ship, a wireless signal power or a manual switching signal, wherein the wireless signal power is a power of a wireless signal which is transmitted to second communication module from the base station.

An exemplary embodiment of the present disclosure provides a coastal calculation center located on a coast. The coastal calculation center is configured to perform data transmission with a ship, and comprises a transmission device comprising a first communication module, a second communication module and a controlling and processing core. The first communication module is configured to communicate with a satellite communication device. The second communication module is configured to communicate with a base station. The controlling and processing core is electrically connected to the first communication module and the second communication module. When the ship is able to communicate with the base station, the coastal calculation center utilizes the second communication module to perform the data transmission with the ship via the base station; when the ship is unable to communicate with the base station, the coastal calculation center utilizes the first communication module to perform the data transmission with the ship via the satellite communication device.

According to the above coastal calculation center, wherein when the ship departs away the coast, the ship is unable to communicate with the base station, and the first communication module of the coastal calculation center is configured to receive real-time health information of the ship via the satellite communication device.

According to the above coastal calculation center, wherein when the ship comes to the coast, the ship is able to communicate with the base station, the second communication module of the coastal calculation center is configured to receive an entire ship data of the ship via the base station, and the coastal calculation center is configured to update a system of the ship and at least a health prediction model of the ship via the base station.

According to the above coastal calculation center, wherein the coastal calculation center performs trend analysis and data correlation analysis based on the entire ship data.

In short, the embodiments of the present disclosure provides a ship communication system, method, a transmission device and a coastal calculation center, wherein when the ship leaves the port on duty, the ship performs the data transmission of the real-time health information with the coastal calculation center through the satellite communication device, and when the ship is close to the coast, the ship performs the data transmission of the entire ship data with the coastal calculation center through the base station. In this way, the present disclosure can allow the coastal calculation center and the ship to realize a complete shipping communication service, and increase the safety of the ship on duty.

### BRIEF DESCRIPTIONS OF DRAWINGS

The present disclosure can be more fully understood by reading the subsequent detailed description and examples with references made to the accompanying drawings, wherein dimensions and arrangement configurations in the drawings are for illustration only, and the present disclosure is not limited thereto. Each figure of the drawings is briefly illustrated as follows

FIG. 1 is a schematic diagram showing a ship communication system according to an embodiment of the present disclosure.

FIG. 2A is a schematic diagram showing a transmission device of a ship according to an embodiment of the present disclosure.

FIG. 2B is a schematic diagram showing a transmission device of a coastal calculation center according to an embodiment of the present disclosure.

FIG. 3 is a flowchart showing a ship communication method according to an embodiment of the present disclosure.

### DETAILS OF EXEMPLARY EMBODIMENT

The following description is of the best-contemplated mode of carrying out the present disclosure. This description is made for the purpose of illustrating the general principles of the present disclosure and should not be taken in a limiting sense. The scope of the present disclosure is best determined by reference to the appended claims.

Embodiments of the present disclosure provide a ship communication system, method, a transmission device and a coastal calculation center. When the ship leaves the port or departs away a coast on duty, the ship performs the data transmission of the real-time health information with the coastal calculation center through the satellite communication device, such that the coastal calculation center can monitor status of the ship leaving the port on duty in real time. When the ship is close to or coming to the coast, the ship performs the data transmission of the entire ship data with the coastal calculation center through the base station (for example, the base station can adopt the fifth-generation mobile communication standard, but the present disclosure is not limited thereto), and the coastal calculation center can perform data transmission of updating a system of the ship and a health prediction model of the ship. Thus, the present disclosure can allow the coastal calculation center and the ship to realize a complete shipping communication service, and increase the safety of the ship on duty.

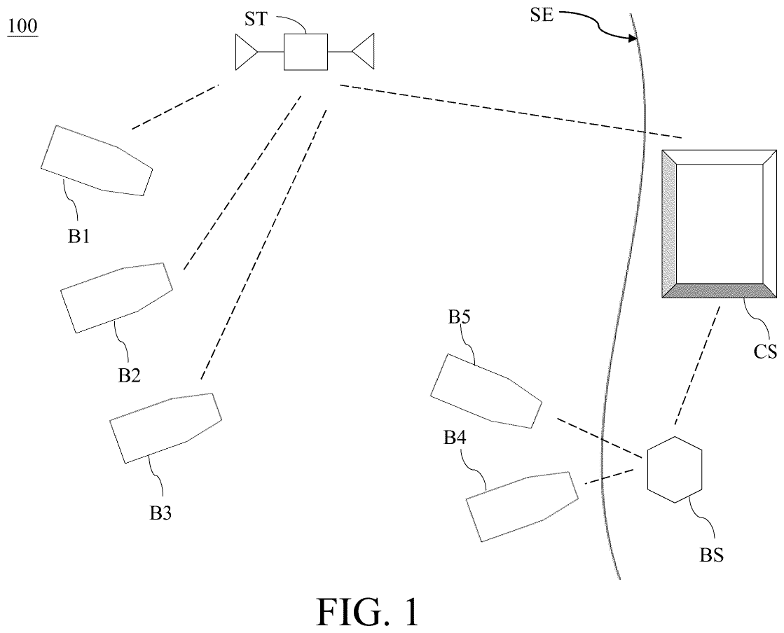

First, refer to FIG. 1, and FIG. 1 is a schematic diagram showing a ship communication system according to an embodiment of the present disclosure. The ship communication system 100 comprises a coastal calculation center CS and at least one of ships B1-B5. The coastal calculation center CS is located on a coast SE and can communicate with the satellite communication device ST and the base station BS. Among the ships B1-B5, the ships B4 and B5 are close to coast SE and can communicate with base station BS, and the ships B1-B5, which are on duty away from the port or the coast SE, cannot communicate with base station BS because they are too far away from base station BS, but still can communication with satellite communication device ST. In addition, the ships B4 and B5 can also communicate with the satellite communication device ST when they do not enter the dock with the shielding roof.

Through the base station BS, the ships B4, B5 can perform the data transmission of the entire ship data with the coastal calculation center CS (i.e. the entire ship data of the ships B4, B5 are transmitted to the coastal calculation center CS via the base station BS), and the coastal calculation center CS can perform the data transmission of updating the systems of the ships B4, B5 and the health prediction models of the ships B4, B5 (i.e. the updating data for the systems and the health prediction models are transmitted to the ships B4, B5 via the base station BS). Through the satellite communication device ST, the ships B1-B3 can perform the data transmission of the real-time health information with the coastal calculation center CS (i.e. the real-time health information of the ships B1-B3 is transmitted to the coastal calculation center CS via the satellite communication device ST).

Furthermore, the coastal calculation center CS can perform trend analysis and data correlation analysis of the ships B4, B5 according to the entire ship data of ships B4, B5, wherein the trend analysis is to analyze the healthiness trends of devices and facilities of the ships B4, B5 and the whole healthiness trends of the ships B4, B5, so that the coastal calculation center CS can assign personnel to perform related maintenances for the ships B4, B5, and the data correlation analysis is to analyze the parameter information of each device and each facility of the ships B4, B5 and the parameter information of the whole ships B4, B5, so as to interpret the correlation between each device, each facility of the ships B4, B5 and the whole ships B4, B5, therefore re-training a better health prediction model.

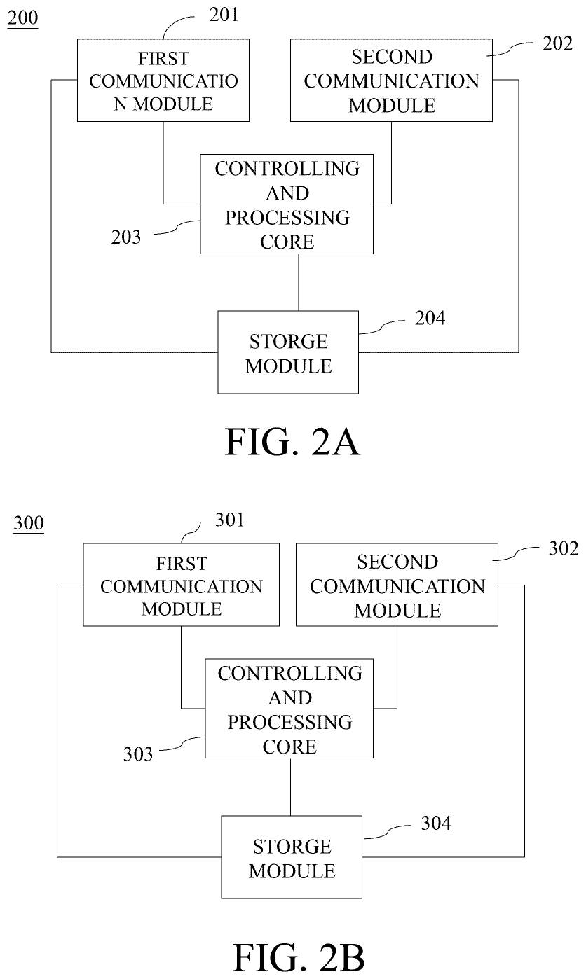

Next, refer to FIG. 1 and FIG. 2A, and FIG. 2A is a schematic diagram showing a transmission device of a ship according to an embodiment of the present disclosure. Each ship B1 to B5 is provided with a transmission device 200, and the transmission device 200 comprises a first communication module 201, a second communication module 202, a controlling and processing core 203 and a storage module 204. The controlling and processing core 203 is electrically connected to the first communication module 201 and the second communication module 202. The storage module 204 is electrically connected to the first communication module 201, the second communication module 202 and the controlling and processing core 203. Incidentally, the storage module 204 can be removed in the present disclosure, and the temporary register or storage space of the controlling and processing core 203 can be used to store data, or the temporary register or storage space of the first communication module 201 and the second communication module 202 can also be used to store data.

The first communication module 201 is configured to communicate with the satellite communication device ST. The second communication module 202 is configured to communicate with the base station BS, wherein the second communication module 202 and the base station BS communicate with each other by using a fourth-generation mobile communication standard, a fifth-generation mobile communication standard, a wireless wide area network standard, a wireless local area network standard, a microwave communication standard or a privacy WiFi (PWifi®) standard, and the present disclosure is not limited thereto. The controlling and processing core 203 is configured to determine whether the second communication module 202 is able to communicate with the base station BS. Specifically, the controlling and processing core 203 determines whether the second communication module 202 is able to communicate with the base station BS according to at least one of a locating signal of the ship, a wireless signal power or a manual switching signal (p.s. when the ship is coming to the coast SE, a member of the ship can manually operate a manual switch to generate the manual switching signal), wherein the wireless signal power is a power of a wireless signal which is transmitted to second communication module 202 from the base station BS.

For example, the locating signals of the ships B4 and B5 indicate that the distances between them and the base station BS are less than the distance threshold, and the power of each of the wireless signals transmitted by the base station BS to the second communication modules 202 of the ships B4 and B5 will not be lower than a power threshold, so the second communication modules 202 of ships B4 and B5 are able to communicate with the base station BS. The locating signals of the ships B1-B3 indicate that their distances from the base station BS are greater than the distance threshold, and the power of each of the wireless signals transmitted by the base station BS to the second communication modules 202 of ships B1-B3 will be lower than the power threshold, so the second communication modules 202 of the ships B1-B3 are not able to communicate with the base station BS.

When the second communication module 202 is communicate with the base station BS, the ship (such as B4, B5) utilizes the second communication module 202 to perform the data transmission with the coastal calculation center CS via the base station BS. When the second communication module 202 is unable to communicate with the base station BS, the ship (such as, B1-B3) utilizes the first communication module 201 to perform the data transmission with the coastal calculation center CS via the satellite communication device ST. In addition, the storage module 204 is used to store the entire ship data of the ship, the real-time health information of the ship (i.e. the real-time health information of each device and each facility and the real-time health information of the whole ship), the health prediction model (i.e. the health prediction models of each device and each facility and the health prediction model of the whole ship) and system information (i.e. the system information of the software used by the ship). Furthermore, the controlling and processing core 203 can use the health prediction model to predict the healthiness score of the device of the ship (such as, one of the ships B1-B5), the healthiness score of the facility of the ship (such as, one of the ships B1-B5) or the healthiness score of the whole ship (such as, one of the ships B1-B5).

In the embodiment, the ships B1-B3 leave the port on duty, the second communication modules 202 of the ships B1-B3 are unable to communicate with the base station BS, and the first communication modules 201 of the ships B1-B3 are utilized to transmit the real-time health information of the ships B1-B3 to the coastal calculation center CS via the satellite communication device ST. In the embodiment, the ships B4 and B5 are close to the coast SE, the second communication modules 202 of the ships B4 and B5 are able communicate with the base station BS, the second communication modules 202 of the ships B4 and B5 are utilized to transmit the entire ship data of the ships B4 and B5 to the coastal calculation center CS via the base station BS, and the coastal calculation center CS can update the system and at least one health prediction model of each of the ships B4 and B5.

Next, refer to FIG. 1 and FIG. 2B, and FIG. 2B is a schematic diagram showing a transmission device of a coastal calculation center according to an embodiment of the present disclosure. The coastal calculation center CS comprises a transmission device 300. The transmission device 300 comprises a first communication module 301, a second communication module 302, a controlling and processing core 303 and a storage module 304. The controlling and processing core 303 is electrically connected to the first communication module 301 and the second communication module 302. The storage module 304 is electrically connected to the first communication module 301, the second communication module 302 and the controlling and processing core 303. By the way, the storage module 304 can be removed from the present disclosure, and the temporary register or storage space of the controlling and processing core 303 can be used to store data, or the temporary register or storage space of the first communication module 301 and the second communication module 302 can also be used to store data.

The first communication module 301 is configured to communicate with the satellite communication device ST. The second communication module 302 is configured to communicate with the base station BS, wherein the second communication module 302 and the base station BS communicate with each other by using a fourth-generation mobile communication standard, a fifth-generation mobile communication standard, a wireless wide area network standard, a wireless local area network standard, a microwave communication standard or a privacy WiFi (PWiFi®) standard, and the present disclosure is not limited thereto. When the ships B4, B5 are able to communicate with the base station BS, the coastal calculation center CS utilizes the second communication module 302 to perform the data transmission with the ships B4, B5 via the base station BS; when the ships B1-B3 are unable to communicate with the base station BS, the coastal calculation center CS utilizes the first communication module 301 o perform the data transmission with the ships B1-B3 via the satellite communication device ST.

Further, the storage module 304 is configured to store the entire ship data of the ship, the real-time health information (i.e. the real-time health information of each device and each facility of the ship and the real-time health information of the whole ship), the health prediction models (i.e. the health prediction models of each device and each facility of the ship and the health prediction model of the whole ship) and system information (i.e. system information of the software used by the ship). Furthermore, the controlling and processing core 303 of the coastal calculation center CS can also perform trend analysis and data correlation analysis of ships B4 and B5 according to the entire ship data of ships B4 and B5.

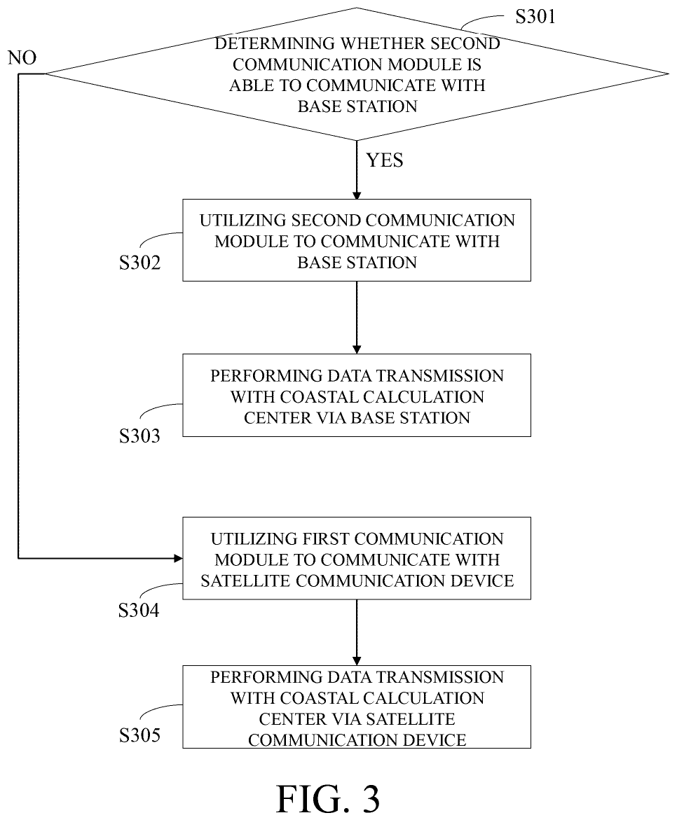

Next, refer to FIG. 3, and FIG. 3 is a flowchart showing a ship communication method according to an embodiment of the present disclosure. The ship communication method in FIG. 3 can be performed by the transmission devices 200 and 300 respectively in FIG. 2A and FIG. 2B. First, at step S301, the ship utilizes the controlling and processing core to determine whether the second communication module is able to communicate with the base station. If the second communication module of the ship is able to communicate with the base station, execute step S302; otherwise, execute step S304. At step S302, the ship utilizes the second communication module to communicate with the base station. At step S303, the ship performs the data transmission with the coastal calculation center via the base station. At step S304, the ship utilizes the first communication module to communicate with the satellite communication device. At step S305, the ship utilizes the first communication module to perform the data transmission with the coastal calculation center via the satellite communication device.

Accordingly, the present disclosure provides a ship communication system and method which make a coastal calculation center communicate with ships depart away from and come to the coast, and further provides a transmission device used in the ship and a coastal calculation center which provides services. In this way, the present disclosure can allow the coastal calculation center and the ship to realize a complete shipping communication service, and increase the safety of the ship on duty.

While the present disclosure has been described by way of example and in terms of preferred embodiment, it is to be understood that the present disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A ship communication system, comprising:
a coastal calculation center, located on a coast; and
at least one of ships, wherein the ship is configured to have a transmission device comprising:
a first communication module, configured to communicate with a satellite communication device;
a second communication module, configured to communicate with a base station; and
a controlling and processing core, electrically connected to the first communication module and the second communication module, configured to determine whether the second communication module is able to communicate with the base station;
wherein when the second communication module is able to communicate with the base station, the ship utilizes the second communication module perform data transmission with the coastal calculation center via the base station; when the second communication module is unable to communicate with the base station, the ship utilizes the first communication module perform data transmission with the coastal calculation center via the satellite communication device.

2. The ship communication system of claim 1, wherein when the ship departs away the coast, the second communication module is unable to communicate with the base station, and the first communication module is utilized to transmit real-time health information of the ship to the coastal calculation center via the satellite communication device.

3. The ship communication system of claim 1, wherein when the ship comes to the coast, the second communication module is able to communicate with the base station, the second communication module is utilized to transmit an entire ship data of the ship to the coastal calculation center via the base station, and the coastal calculation center updates a system of the ship and at least a health prediction model of the ship are updated via the base station.

4. The ship communication system of claim 3, wherein the coastal calculation center performs trend analysis and data correlation analysis based on the entire ship data.

5. The ship communication system of claim 3, wherein the controlling and processing core is configured to predicate a healthiness score of a device in the ship, a healthiness score of a facility in the ship or a healthiness score of the entire ship by using the health prediction model.

6. The ship communication system of claim 1, wherein the transmission device further comprises:
a storage module, electrically connected to the first communication module, the second communication module and the controlling and processing core, configured to store an entire ship data of the ship, real-time health information of the ship, a health prediction model and system information.

7. The ship communication system of claim 1, wherein the second communication module communicates with the base station by using a fourth-generation mobile communication standard, a fifth-generation mobile communication standard, a wireless wide area network standard, a wireless local area network standard, a microwave communication standard or a privacy WiFi (PWiFi®) standard.

8. The ship communication system of claim 1, wherein the controlling and processing core determines whether the second communication module is able to communicate with the base station according to at least one of a locating signal of the ship, a wireless signal power or a manual switching signal, wherein the wireless signal power is a power of a wireless signal which is transmitted to second communication module from the base station.

9. A ship communication method, comprising:
determining whether a ship is able to communicate with a base station;
when the ship is unable to communicate with the base station, the ship performs data transmission with a coastal calculation center located on a coast via a satellite communication device; and
when the ship is able to communicate with the base station, the ship performs the data transmission with the coastal calculation center via the base station.

10. A transmission device, used in a ship, configured to perform data transmission with a coastal calculation center located on a coast, comprising:
a first communication module, configured to communicate with a satellite communication device;
a second communication module, configured to communicate with a base station; and
a controlling and processing core, electrically connected to the first communication module and the second communication module, configured to determine Whether the second communication module is able to communicate with the base station;
wherein when the second communication module is able to communicate with the base station, the ship utilizes the second communication module to perform the data transmission with the coastal calculation center via the base station; when the ship is unable to communicate with the base station, the ship utilizes the first communication module to perform data transmission with the coastal calculation center via the satellite communication device.

11. The transmission device of claim 10, wherein when the ship departs away the coast, the second communication module is unable to communicate with the base station, and the first communication module is utilized to transmit real-time health information of the ship to the coastal calculation center via the satellite communication device.

12. The transmission device of claim 10, wherein when the ship comes to the coast, the second communication module is able to communicate with the base station, the second communication module is utilized to transmit an entire ship data of the ship to the coastal calculation center via the base station, and the coastal calculation center updates a system of the ship and at least a health prediction model of the ship are updated via the base station.

13. The transmission device of claim 12, wherein the controlling and processing core is configured to predicate a healthiness score of a device in the ship, a healthiness score of a facility in the ship or a healthiness score of the entire ship by using the health prediction model.

14. The transmission device of claim 10, wherein the transmission device further comprises:
a storage module, electrically connected to the first communication module, the second communication module and the controlling and processing core, configured to store an entire ship data of the ship, real-time health information of the ship, a health prediction model and system information.

15. The transmission device of claim 10, wherein the second communication module communicates with the base station by using a fourth-generation mobile communication standard, a fifth-generation mobile communication standard, a wireless wide area network standard, a wireless local area network standard, a microwave communication standard or a privacy WiFi (PWiFi®) standard.

16. The transmission device of claim 10, wherein the controlling and processing core determines whether the second communication module is able to communicate with the base station according to at least one of a locating signal of the ship, a wireless signal power or a manual switching signal, wherein the wireless signal power is a power of a wireless signal which is transmitted to second communication module from the base station.

17. A coastal calculation center, located on a coast, configured to perform data transmission with a ship, comprising:
a transmission device, comprising:
a first communication module, configured to communicate with a satellite communication device;
a second communication module, configured to communicate with a base station; and
a controlling and processing core, electrically connected to the first communication module and the second communication module;
wherein when the ship is able to communicate with the base station, the coastal calculation center utilizes the second communication module to perform the data transmission with the ship via the base station; when the ship is unable to communicate with the base station, the coastal calculation center utilizes the first communication module to perform the data transmission with the ship via the satellite communication device.

18. The coastal calculation center of claim 17, wherein when the ship departs away the coast, the ship is unable to communicate with the base station, and the first communication module of the coastal calculation center is configured to receive real-time health information of the ship via the satellite communication device.

19. The coastal calculation center of claim 17, wherein when the ship comes to the coast, the ship is able to communicate with the base station, the second communication module of the coastal calculation center is configured to receive an entire ship data of the ship via the base station, and the coastal calculation center is configured to update a system of the ship and at least a health prediction model of the ship via the base station.

20. The coastal calculation center of claim 19, wherein the coastal calculation center performs trend analysis and data correlation analysis based on the entire ship data.
